(19) United States
(12) Patent Application Publication
(10) Pub. No.: US 2025/0262124 A1
(43) Pub. Date: Aug. 21, 2025

(54) JEWELRY DEVICE HAVING ROTATABLE ACUPRESSURE MECHANISM

(71) Applicant: Harmonia Jewelry, LLC, Los Angeles, CA (US)

(72) Inventor: Kali Luna Summer, Los Angeles, CA (US)

(73) Assignee: Harmonia Jewelry, LLC, Los Angeles, CA (US)

(21) Appl. No.: 19/055,044

(22) Filed: Feb. 17, 2025

Related U.S. Application Data
(60) Provisional application No. 63/555,663, filed on Feb. 20, 2024.

(51) Int. Cl. A61H 39/04; A44C 5/00; A61H 15/00

(52) U.S. Cl. CPC A61H 39/04; A44C 5/0023; A61H 15/00; A61H 2015/0042; A61H 2201/1253; A61H 2201/1638; A61H 2201/165; A61H 2201/169; A61H 2205/027; A61H 2205/067

(57) ABSTRACT

A jewelry device for applying acupressure to a location on a wearers skin includes a band and an accessory rotatably connected about an axis thereof to the band. The band includes a first end point, a second end point, and a longitudinal section extending between the first end point and the second end point. The accessory includes at least one domed surface.

### CROSS REFERENCES AND PRIORITIES

The Application claims priority from U.S. Provisional Application No. 63/555,663 filed on 20 Feb. 2024, the teachings of which are incorporated by reference herein in its entirety.

### BACKGROUND

Acupressure is a traditional Chinese therapeutic technique involving the stimulation of certain nerves and nerve junctions by manual massage and pressure of those same nerve junctions to produce a certain physiological effect. The use of acupressure has effectively been in use of many centuries as treatment for a variety of physiological conditions and ailments.

For example, when traveling in an automobile, train, airplane, ship, or the like, many people experience motion sickness. On occasion, motion sickness can rise to a level of severity that the person traveling must temporarily or permanently stop their trip. This can be difficult when the trip is conducted by a train, airplane, or ship which stops only at scheduled times.

Attempts have been made to ease the symptoms of motion sickness and other ailments using acupressure. The most basic attempts involve a wearable device that attaches to the wearers wrist and includes an acupressure attachment which—when the wrist-worn device is applied tightly to the user's wrist—stimulates the nerves and nerve junctions.

One such device is disclosed in United States Patent Publication No. 2004/0044362 A1 which describes a clasp for securing a piece of jewelry around a wrist of a wearer and for relieving symptoms of motion sickness has a base member. A protrusion is formed on a surface of the base member. The protrusion will apply pressure to a wrist area of a wear to relieve symptoms of motion sickness. A locking arm is hingely coupled to the base member. The locking arm is used for securing the clasp around the wrist of the wearer.

In practice, the existing devices suffer from several flaws. Most notably, existing acupressure devices typically require removal of the device in its entirety in order to cease the acupressure treatment. When the acupressure treatment is to be resumed, the wearer then has to reapply the entire device. In addition, existing devices are often not aesthetically pleasing such that they may be worn as a piece of jewelry or similar fashion accessory.

The need exists, therefore, for an improved device for applying acupressure to a location on a wearers skin which is aesthetically pleasing and for which the acupressure treatment can be stopped and resumed without having to remove and reattach the device.

### SUMMARY

This specification discloses a jewelry device for applying acupressure to a location on a wearer's skin. It is disclosed that in some embodiments, the device comprises a band having a first end point, a second end point, and a longitudinal section extending between the first end point and the second end point. Further, it discloses in some embodiments an accessory having at least one domed surface, said accessory being rotatable connected to the band about a latitudinal axis of the accessory.

This specification further discloses that in some embodiments, the band is rigid along a length of the longitudinal section between the first end point and the second end point. Further, in some embodiments wherein the band is rigid along a length of the longitudinal section between the first end point and the second end point, the band may comprise a hinge within the longitudinal section between the first end point and the second end point.

Disclosed further in this specification, in some embodiments, the band is flexible along a length of the longitudinal section between the first end point and the second end point. Further, in some embodiments wherein the band is flexible along a length of the longitudinal section between the first end point and the second end point, the band may comprise a length adjustment mechanism.

Further disclosed, in some embodiments the accessory is rotatably connected to the band by passing a portion of the longitudinal section through a hole passing through the latitudinal axis.

This specification further discloses that in some embodiments wherein the band is flexible along a length of the longitudinal section between the first end point and the second end point, the accessory is rotatably connected to the band by passing a portion of the longitudinal section through a hole passing through the latitudinal axis.

Disclosed further, in some embodiments wherein the band is flexible along a length of the longitudinal section between the first end point and the second end point and the band is flexible along a length of the longitudinal section between the first end point and the second end point and the band comprises a length adjustment mechanism, the accessory is rotatably connected to the band by passing a portion of the longitudinal section through a hole passing through the latitudinal axis.

Disclosed further in this specification, in some embodiments the band may comprise a yoke located at the first end point, the second end point, or along a length of the longitudinal section, and the accessory is rotatably connected to the yoke by a pin which passes through a hole passing through the latitudinal axis.

This specification further discloses that in some embodiments wherein the band is rigid along a length of the longitudinal section between the first end point and the second end point, the band may comprise a yoke located at the first end point, the second end point, or along a length of the longitudinal section, and the accessory is rotatably connected to the yoke by a pin which passes through a hole passing through the latitudinal axis.

Further disclosed, in some embodiments wherein the band is rigid along a length of the longitudinal section between the first end point and the second end point and the band comprises a hinge within the longitudinal section between the first end point and the second end point, the band may comprise a yoke located at the first end point, the second end point, or along a length of the longitudinal section, and the accessory is rotatably connected to the yoke by a pin which passes through a hole passing through the latitudinal axis.

Disclosed further, in some embodiments the accessory of the jewelry device comprises a first eyelet extending from a first position on the accessory parallel to the latitudinal axis, and a second eyelet extending from a second position on the accessory opposite the first position. Further, a first portion of the band, which may be the first end point, is connected to the first eyelet, and a second portion of the band, which may be the second end point, is connected to the second eyelet.

Further disclosed in this specification, in some embodiments the band may comprise a material selected from a group consisting of cloth, leather, plastic, steel, aluminum, or the like. In some embodiments wherein the band is rigid along a length of the longitudinal section between the first end point and the second end point, the band may comprise a material selected from a group consisting of cloth, leather, plastic, steel, aluminum, or the like.

Further disclosed, in some embodiments, the accessory may comprise a material selected from a group consisting of steel, aluminum, titanium, copper, plastic, wood, stone, or the like. In some embodiments wherein the band is rigid along a length of the longitudinal section between the first end point and the second end point, or the band is flexible along a length of the longitudinal section between the first end point and the second end point and the band is flexible along a length of the longitudinal section between the first end point and the second end point and the band comprises a length adjustment mechanism, the accessory may comprise a material selected from a group consisting of steel, aluminum, titanium, copper, plastic, wood, stone, or the like.

Disclosed further, in some embodiments, the jewelry device may be a wrist bracelet. In other embodiments, the jewelry device may be a finger ring. Further, in other embodiments, the jewelry device may be an earring.

### BRIEF DESCRIPTION OF FIGURES

FIG. 1 illustrates a perspective view of a jewelry device for applying acupressure to a location on a wearers skin.

FIG. 2 illustrates an exploded view of a jewelry device for applying acupressure to a location on a wearers skin.

FIG. 3A illustrates a jewelry device having an accessory for applying acupressure to a location on a wearers skin in a first position.

FIG. 3B illustrates a jewelry device having an accessory for applying acupressure to a location on a wearers skin in a second position.

FIG. 4 illustrates a perspective view of a jewelry device for applying acupressure to a location on a wearers skin.

FIG. 5 illustrates a jewelry device for applying acupressure to a location on a wearers skin worn on a person's wrist.

FIG. 6 illustrates a perspective view of a jewelry device for applying acupressure to a location on a wearers skin.

FIG. 7 illustrates an exploded view of a jewelry device for applying acupressure to a location on a wearers skin.

FIG. 8 illustrates an embodiment for attaching an accessory to a band.

FIG. 9 illustrates an embodiment for attaching an accessory to a band.

FIG. 10 illustrates an embodiment for attaching an accessory to a band.

### DETAILED DESCRIPTION

Disclosed herein is a jewelry device for applying acupressure to a location on a wearers skin. As described herein and in the claims, the following numbers refer to the following structures as noted in the Figures.

10 refers to a jewelry device.

100 refers to a band.

110 refers to a first end point.

120 refers to a second end point.

130 refers to a longitudinal section.

140 refers to a hinge.

150 refers to a length adjustment mechanism.

160 refers to a yoke.

200 refers to an accessory.

210 refers to a domed surface.

220 refers to an axis.

225 refers to a hole.

230 refers to a pin.

240 refers to a first eyelet.

250 refers to a second eyelet.

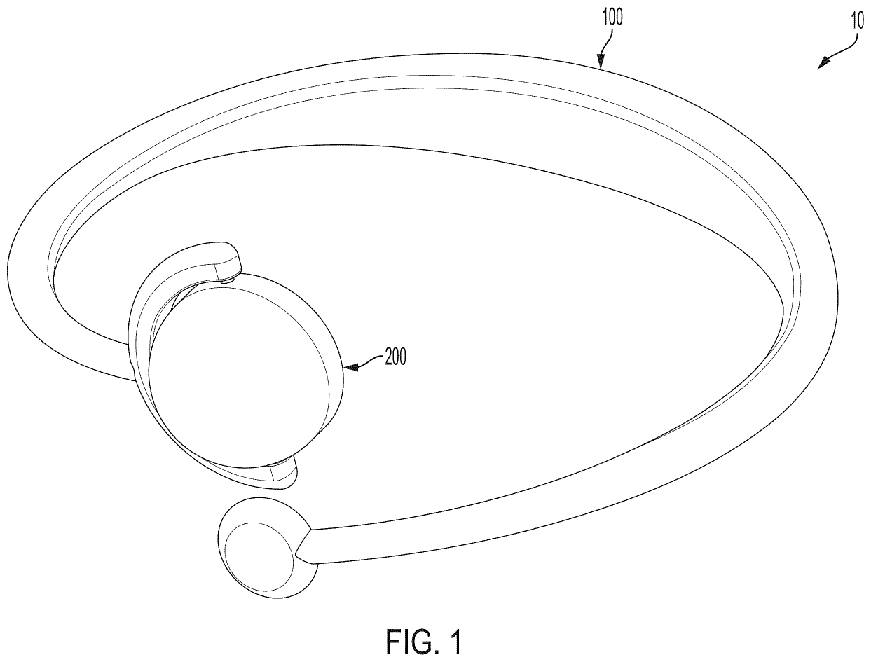

FIG. 1 illustrates an embodiment of a jewelry device (10) for applying acupressure to a location on a wearers skin. As shown in FIG. 1, the jewelry device includes a band (100) and an accessory (200) connected thereto.

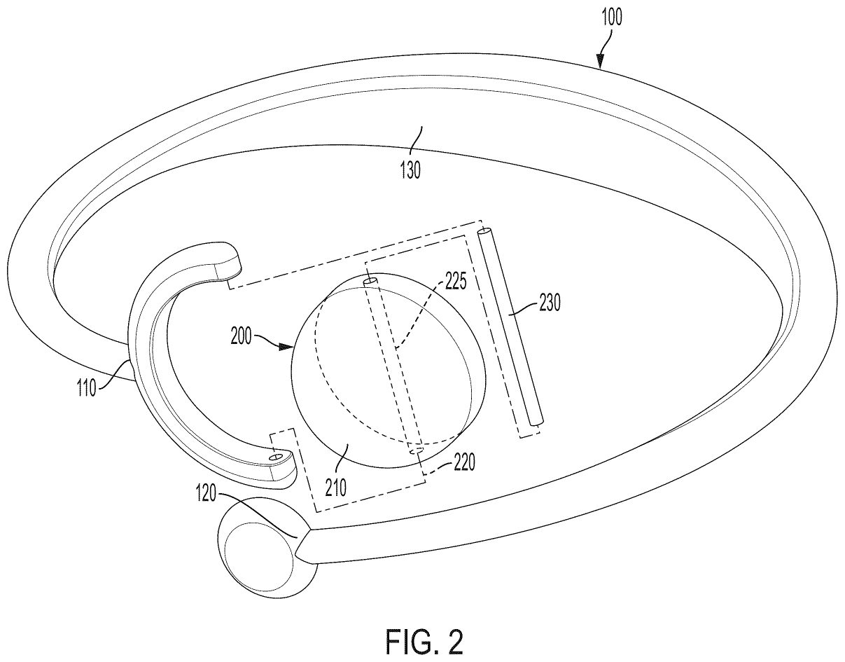

FIG. 2 illustrates a jewelry device (10) in exploded view including the band (100) and the accessory (200). As shown in FIG. 2, the band includes a first end point (110), a second end point (120), and a longitudinal section (130) extending between the first end point and the second end point.

While many embodiments of a band (100) may exist, in the embodiment shown in FIG. 2, the band is a rigid band. That is to say that the band is rigid along a length of the longitudinal section between the first end point and the second end point. A rigid band is defined as not being able to bend or be forced out of shape along the entire length of the band in the absence of an external force which is equal to or less than the force of gravity.

Preferably, the longitudinal section (130) of the band (100) between the first end point (110) and the second end point (120) will form a shape which is not a straight line. For example, when the jewelry device is in the form of a bracelet or finger ring, the longitudinal section between the first end point and the second end point will form a circular or semi-circular shape as shown in FIG. 2.

FIG. 2 also shows certain features of an accessory (200). As shown in FIG. 2, the accessory includes a domed surface (210). Preferably, a surface opposite the domed surface will be flat or substantially flat such that the accessory has a substantially hemispherical shape as shown in FIG. 2. As the accessory includes a domed surface, the accessory will have a latitudinal axis (220) and a longitudinal axis (221) as illustrated in FIG. 2.

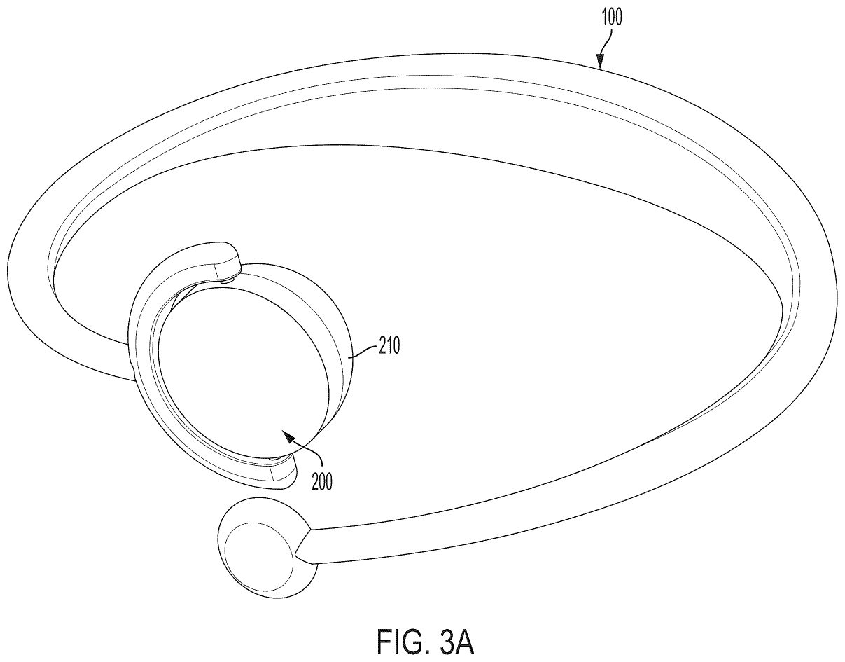

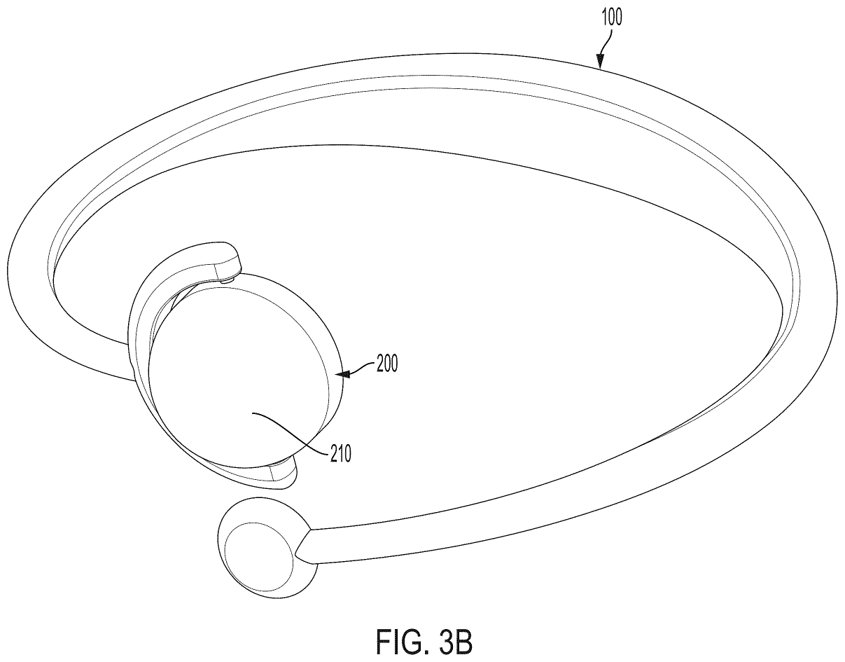

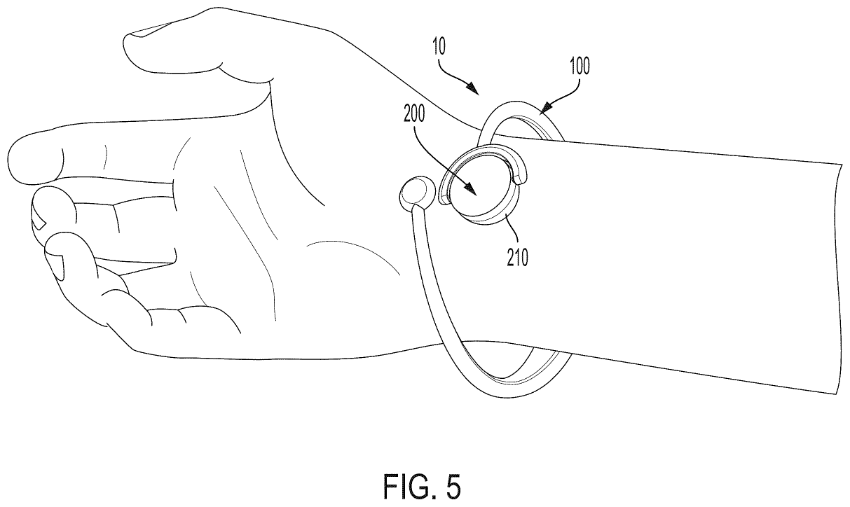

The connection between the band (100) and the accessory (200) is such that the accessory may rotate about the latitudinal axis (220) without the wearer removing the jewelry device. FIG. 3A and FIG. 3B illustrates the rotation of the accessory about the latitudinal axis. In FIG. 3A the accessory is rotated to a first position in which the domed surface (210) faces inwardly towards the wearers skin (as illustrated in FIG. 5). This may be thought of as an operative position in which the domed surface applies acupressure to a location on the wearers skin. When the wearer does not wish to have acupressure applied, the wearer simply uses their fingers or a similar device to rotate the accessory about the latitudinal axis until the domed surface faces outwardly away from the wearers skin as shown in FIG. 3B. This may be thought of as a non-operative position in which the domed surface does not apply acupressure to any location on the wearers skin.

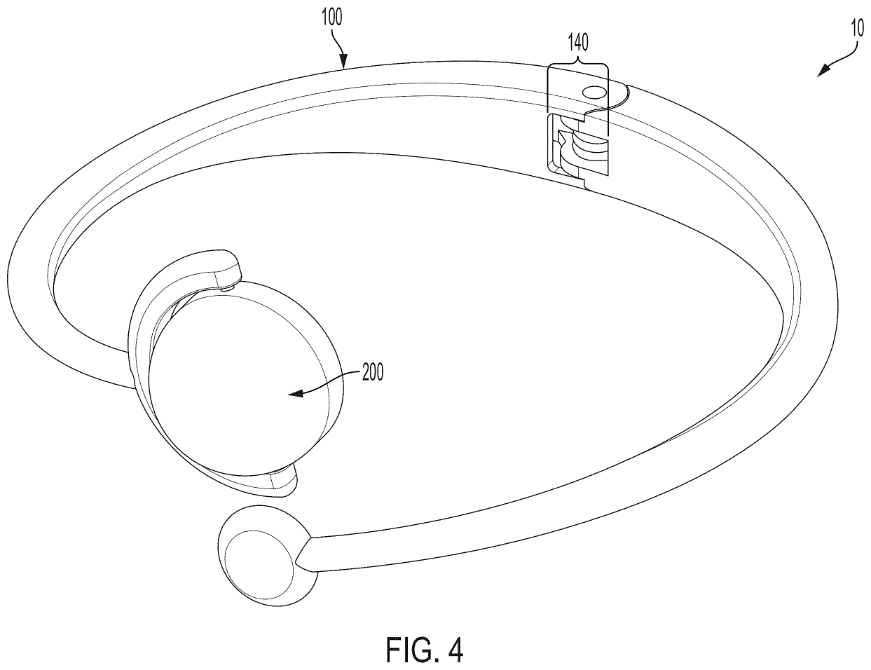

FIG. 4 illustrates an embodiment of a band (100) which is rigid. In the embodiment shown in FIG. 4, the band includes a hinge (140) within the longitudinal section (130) between the first end point (110) and the second end point (120). The hinge allows the rigid band to expand and contract about the hinge axis so that the wearer may easily put on or remove the jewelry device.

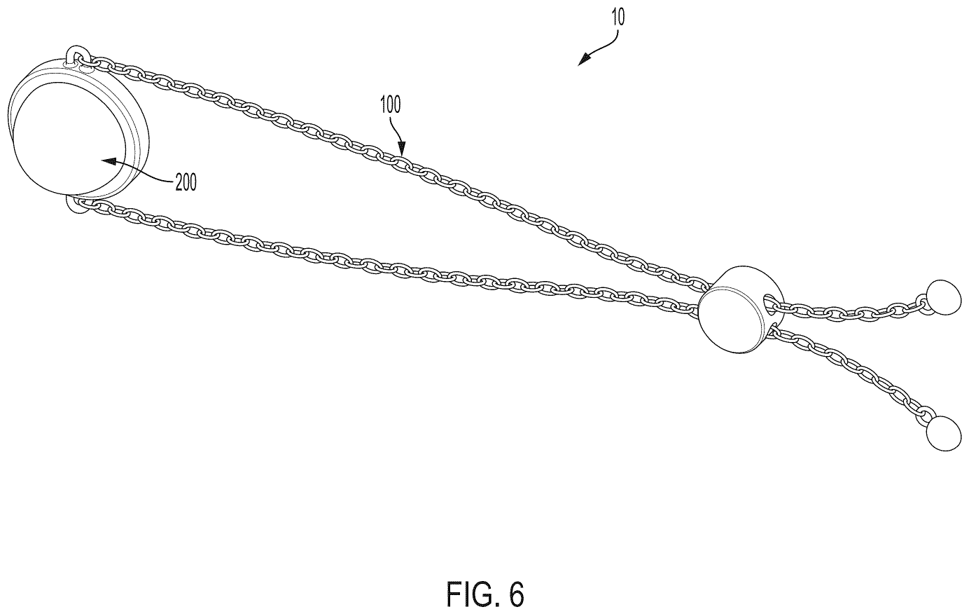

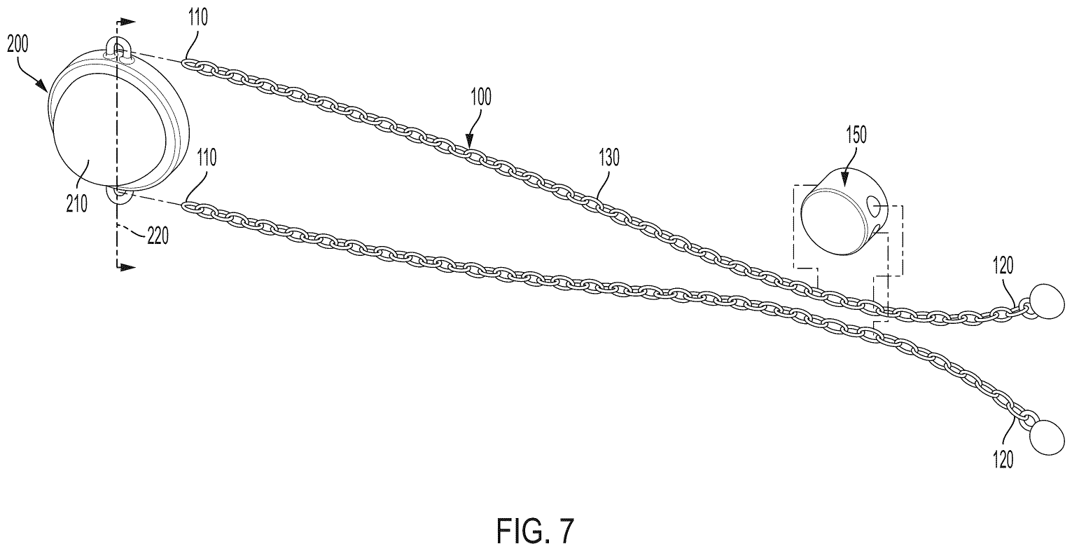

FIG. 6 and FIG. 7 illustrate a separate embodiment of a jewelry device (10). In the embodiment shown in FIG. 6 and FIG. 7 the band (100) is flexible along a length of the longitudinal section (130) between the first end point (110) and the second end point (120). A flexible band is defined as being able to change shape along the entire length of the band in the absence of an external force such which is less than the force of gravity.

In some embodiments, the band may include a length adjustment mechanism (150) such as the one illustrated in FIG. 7. When present, the length adjustment mechanism may include a member comprising one or more through holes through which the band may slideably extend.

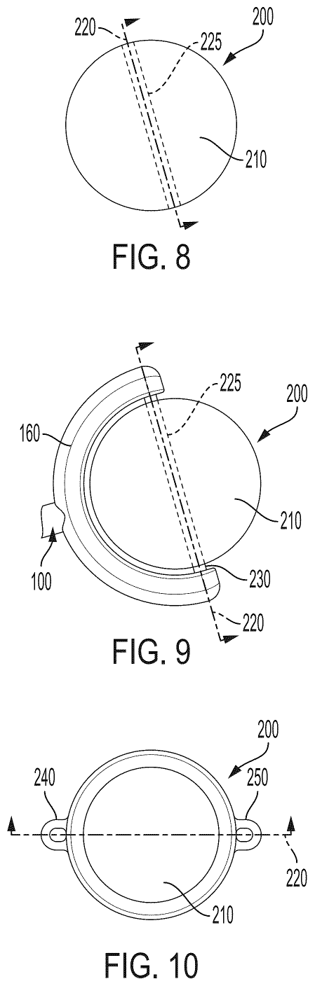

FIG. 8 through FIG. 10 illustrate examples of connecting an accessory (200) to a band (100). In FIG. 8, the accessory includes a hole (225) passing through the latitudinal axis (220) with a portion of the longitudinal section (130) of the band passing through the hole. The longitudinal section then serves as a pivot about which the accessory may rotate to change the domed surface (210) from an operative position to a non-operative position and vice versa.

In FIG. 9, the band includes a yoke (160) located at the first end point (110), the second end point (120), or along a length of the longitudinal section (130). The accessory in FIG. 9 includes a hole (225) passing through the latitudinal axis (220). A pin (230) passes through the hole and connects the accessory to the yoke. The pin then serves as a pivot about which the accessory may rotate to change the domed surface (210) from an operative position to a non-operative position and vice versa.

In FIG. 10, the accessory (200) includes a first eyelet (240) and a second eyelet (250). The first eyelet extends from a first position on the accessory parallel to the latitudinal axis while the second eyelet extends from a second position on the accessory opposite the first position. A first portion of the band—which may be the first end point (110)—connects to the first eyelet while a second portion of the band—which may be the second end point (120) connects to the second eyelet. The eyelets then serve as a pivot about which the accessory may rotate to change the domed surface (210) from an operative position to a non-operative position and vice versa.

Preferred embodiments of the jewelry device are intended to be worn as a decorative item for personal adornment. As such, the jewelry device—including the band and/or the accessory—may be made of precious metals such as gold, silver, platinum, and the like. However, embodiments may exist in which the band is made of a material such as cloth, leather, plastic, steel, aluminum, or the like. Embodiments may also exist in which the accessory is made of a material such as steel, aluminum, titanium, copper, plastic, wood, stone, or the like. When the material is stone, it may be selected from a group consisting of diamonds, rubies, sapphires, amethysts, garnets, topaz, opals, pearls, peridots, quartz, and the like.

While the Figures illustrate a jewelry device in the form of a wrist bracelet, other embodiments may also exist. For example, the jewelry device may be in the form of a finger ring. The jewelry device may also be in the form of an earring.

The jewelry devices disclosed herein are capable of applying acupressure treatment to a location on a wearers skin. Specifically, when the jewelry device is attached tightly to a user's wrist, finger, ear, or to another location on the wearer's skin, the accessory may apply acupressure when the domed surface is configured in the direction of the wearer's skin. The acupressure treatment may be ceased—without removing the device entirely—by simply rotating the accessory such that the domed surface faces away from the wearer's skin. When the wearer desires to resume the acupressure treatment, they may do so—without having to reapply the jewelry device—by simply rotating the accessory such that the domed surface is once again facing the wearer's skin.

While the jewelry device has been described as having one or more exemplary designs, the present jewelry device may be further modified within the spirit and scope of this disclosure. This application is therefore intended to cover any variations, uses, or adaptations of the jewelry device disclosed herein using their general principles.

What is claimed is:

1. A jewelry device (10) for applying acupressure to a location on a wearer's skin, said jewelry device comprising:
a band (100) having a first end point (110), a second end point (120), and a longitudinal section (130) extending between the first end point and the second end point; and
an accessory (200) having at least one domed surface (210), said accessory being rotatably connected to the band about a latitudinal axis (220) of the accessory.

2. The jewelry device of claim 1, wherein the band is rigid along a length of the longitudinal section between the first end point and the second end point.

3. The jewelry device of claim 2, wherein the band comprises a hinge (140) within the longitudinal section between the first end point and the second end point.

4. The jewelry device of claim 1, wherein the band is flexible along a length of the longitudinal section between the first end point and the second end point.

5. The jewelry device of claim 4, wherein the band comprises a length adjustment mechanism (150).

6. The jewelry device of claim 1, wherein the accessory is rotatably connected to the band by passing a portion of the longitudinal section through a hole (225) passing through the latitudinal axis.

7. The jewelry device of claim 4, wherein the accessory is rotatably connected to the band by passing a portion of the longitudinal section through a hole (225) passing through the latitudinal axis.

8. The jewelry device of claim 5, wherein the accessory is rotatably connected to the band by passing a portion of the longitudinal section through a hole (225) passing through the latitudinal axis.

9. The jewelry device of claim 1, wherein the band comprises a yoke (160) located at the first end point, the second end point, or along a length of the longitudinal section, and the accessory is rotatably connected to the yoke by a pin (230) which passes through a hole (225) passing through the latitudinal axis.

10. The jewelry device of claim 2, wherein the band comprises a yoke (160) located at the first end point, the second end point, or along a length of the longitudinal section, and the accessory is rotatably connected to the yoke by a pin (230) which passes through a hole (225) passing through the latitudinal axis.

11. The jewelry device of claim 3, wherein the band comprises a yoke (160) located at the first end point, the second end point, or along a length of the longitudinal section, and the accessory is rotatably connected to the yoke by a pin (230) which passes through a hole (225) passing through the latitudinal axis.

12. The jewelry device of claim 1, wherein the accessory comprises:
a first eyelet (240) extending from a first position on the accessory parallel to the latitudinal axis, and
a second eyelet (250) extending from a second position on the accessory opposite the first position, and
wherein a first portion of the band which may be the first end point is connected to the first eyelet, and a second portion of the band which may be the second end point is connected to the second eyelet.

13. The jewelry device of claim 1, wherein the band comprises a material selected from a group consisting of cloth, leather, plastic, steel, aluminum, or the like.

14. The jewelry device of claim 3, wherein the band comprises a material selected from a group consisting of cloth, leather, plastic, steel, aluminum, or the like.

15. The jewelry device of claim 1, wherein the accessory comprises a material selected from a group consisting of steel, aluminum, titanium, copper, plastic, wood, stone, or the like.

16. The jewelry device of claim 3, wherein the accessory comprises a material selected from a group consisting of steel, aluminum, titanium, copper, plastic, wood, stone, or the like.

17. The jewelry device of claim 5, wherein the accessory comprises a material selected from a group consisting of steel, aluminum, titanium, copper, plastic, wood, stone, or the like.

18. The jewelry device of claim 1, wherein the jewelry device is a wrist bracelet.

19. The jewelry device of claim 1, wherein the jewelry device is a finger ring.

20. The jewelry device of claim 1, wherein the jewelry device is an earring.
